(19) United States
(12) Patent Application Publication
(10) Pub. No.: US 2006/0128326 A1
(43) Pub. Date: Jun. 15, 2006

(54) Low complexity adaptive channel estimation

(75) Inventor: Philip J. Pietraski, Huntington Station, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/007,998

(22) Filed: Dec. 9, 2004

(51) Int. Cl. G06F 3/033

(52) U.S. Cl. 455/130

(57) ABSTRACT

A channel estimation apparatus and method is provided for a wireless communication signal received from at least one relatively mobile wireless transmit/receive unit (WTRU). Predetermined filter coefficients having unique index values are stored in a memory device. An index generator matches estimation values of the mobile unit speed and SNR to a particular filter coefficient, and selects a corresponding index value, whereby the memory performs a look up function according to the index value and outputs a filter coefficient vector. The channel estimation of the wireless communication signal is taken from the output of the filter. Alternatively, a set of parallel filters which run continuously are used to produce several channel estimates, from which the final estimate is selected based on the associated lowest mean square error or highest SNR.

### FIELD OF INVENTION

The invention generally relates to wireless communication systems. In particular, the invention relates to adaptive channel estimation in such systems.

### BACKGROUND

The terms base station, wireless transmit/receive unit (WTRU) and mobile unit are used in their general sense. As used herein, a wireless transmit/receive unit (WTRU) includes, but is not limited to, a user equipment, mobile station fixed or mobile subscriber unit, pager, or any other type of device capable of operating in a wireless environment. WTRUs include personal communication devices, such as phones, video phones, and Internet ready phones that have network connections. In addition, WTRUs include portable personal computing devices, such as PDAs and notebook computers with wireless modems that have similar network capabilities. WTRUs that are portable or can otherwise change location are referred to as mobile units. When referred to hereafter, a base station is a WTRU that includes, but is not limited to, a base station, Node B, site controller, access point, or other interfacing device in a wireless environment.

Wireless telecommunication systems are well known in the art. In order to provide global connectivity for wireless systems, standards have been developed and are being implemented. One current standard in widespread use is known as Global System for Mobile Telecommunications (GSM). This is considered as a so-called Second Generation mobile radio system standard (2G) and was followed by its revision (2.5G). GPRS and EDGE are examples of 2.5G technologies that offer relatively high speed data service on top of (2G) GSM networks. Each one of these standards sought to improve upon the prior standard with additional features and enhancements. In January 1998, the European Telecommunications Standard Institute—Special Mobile Group (ETSI SMG) agreed on a radio access scheme for Third Generation Radio Systems called Universal Mobile Telecommunications Systems (UMTS). To further implement the UMTS standard, the Third Generation Partnership Project (3GPP) was formed in December 1998. 3GPP continues to work on a common third generational mobile radio standard.

A typical cellular configuration 10 is depicted in FIG. 1A, where cell 20 includes a base station 25 and mobile WTRUs 35, 45. In general, the primary function of base stations, such as Node Bs, is to provide a radio connection along physical channels between the base stations' network and the WTRUs. A typical wireless local area network (WLAN) configuration is shown in FIG. 1B. Similar to the cellular configuration of FIG. 1A, WLAN 50 comprises a central access point, and mobile WTRUs 56 and 57. Here, wireless communications are carried on between WTRUs 56 and 57 via access point 55 according to IEEE 802.11 and related WLAN standards. Good quality channel estimation is an important part of a high performance receiver in both the base station 25 and the WTRUs 35, 45, as well as the access point 55 and WTRUs 56, 57.

One of the problems with channel estimation in typical wireless channels is that the states of the channels change with time, or, in other words, the channels fade. If the fading statistics are fixed and known to the receiver, an optimal channel estimation filter, or algorithm, can be derived and used in the receiver with little implementation complexity. However, in various contexts actual channel fading statistics vary with time, such as when the velocity of a mobile unit changes. Accordingly, a fixed filter cannot deliver the optimum performance in such cases.

FIG. 2 shows a graphical representation of a channel estimation filter's performance. Curves 11 and 12 represent channel throughput as a function of averaging time used by a moving average type filter, for two channels 110, 120 of wireless communication with mobile WTRUs 35, 45, respectively. WTRU 35 has a rate of speed of 3 kph, while WTRU 45 is traveling at a rate of 120 kph. As shown in FIG. 2, a filter cannot be simultaneously optimized for both channels. At 3 kph, the optimum filter length is well above 1.4 slots, while the optimal length is as low as 0.6 slots for a 120 kph mobile unit. Even shorter filter lengths would be required for 250 kph channel required by 3GPP.

### SUMMARY

A channel estimation apparatus and method is provided for a wireless communication signal received from at least one relatively mobile wireless transmit/receive unit (WTRU). Preferably, a receiver for a WTRU, such as a base station, is configured to determine an estimation of the mobile receiver speed and an estimation of the signal-to-noise ratio (SNR) of the mobile WTRU transmissions. Preferably, the receiver has a correlator, a memory device, an index generator and an associated filter. The correlator is preferably configured to receive the communication signal data and produce pilot symbols. Predetermined filter coefficients having unique index values are preferably stored in the memory device. The index generator is preferably configured to match speed estimation values and SNR estimation values to a particular set of filter coefficients and to select corresponding index values. Accordingly, the memory is preferably configured to perform a look up function according to the index value and outputs a filter coefficient vector. In operation, the pilot symbols are filtered, resulting in a channel estimation of the wireless communication signal.

In an alternate embodiment, multiple channel estimation filters are preferably provided which are configured to run continuously for producing multiple candidate channel estimations. Each candidate channel estimation is preferably self assessed for quality of the estimation by having a mean square error (MSE) estimation of the channel estimation calculated. The candidate channel estimation having the lowest MSE estimation value is selected as the final channel estimation. One alternative is to configure the apparatus such that the SNR estimation for each candidate channel estimation is determined from the MSE, and the candidate channel estimation having the highest SNR value is selected as the final channel estimation.

Other objects and advantages of the present invention will be apparent to those skilled in the art from the following detailed description and accompanying drawings.

### BRIEF DESCRIPTION OF THE DRAWING(S)

FIG. 1A is a diagrammatic representation of a typical physical configuration of wireless communication between a base station and wireless transmit/receive units.

FIG. 1B is a diagrammatic representation of a typical physical configuration of a wireless LAN communication between an access point and wireless transmit/receive units.

FIG. 2 is a graphical representation of simulated channel estimation performance of a moving average filter's throughput loss as a function of averaging time.

FIG. 3 is a block diagram of an adaptive channel estimation filter according to a first embodiment of the present invention.

FIG. 4 is a method flowchart for adaptive channel estimation as performed by the filter of FIG. 3.

FIG. 5 is a block diagram of an adaptive channel estimation filter according to a second embodiment of the present invention.

FIG. 6 is a method flowchart for adaptive channel estimation as performed by the filter of FIG. 5.

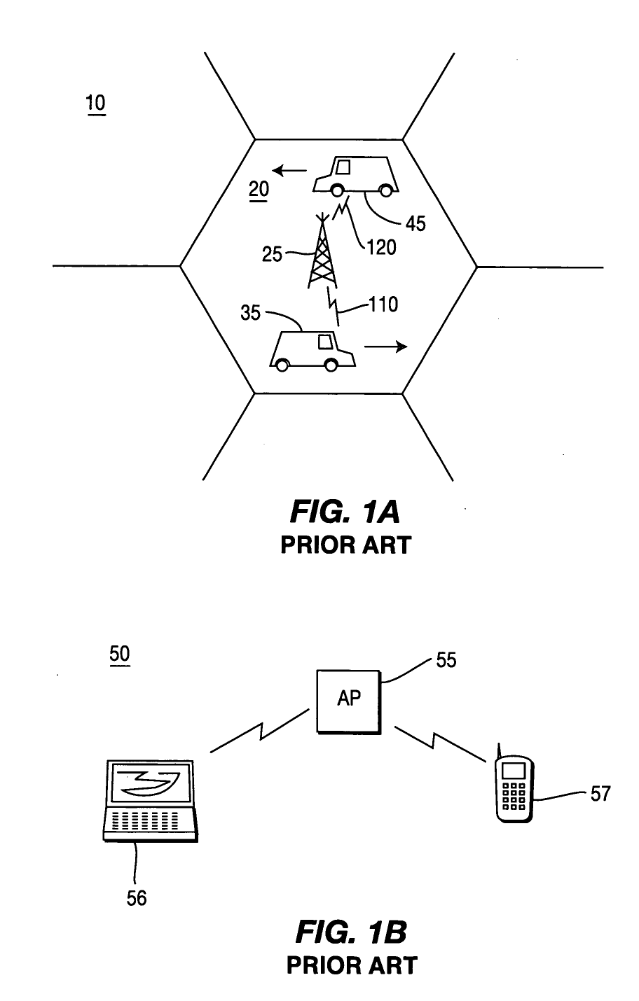

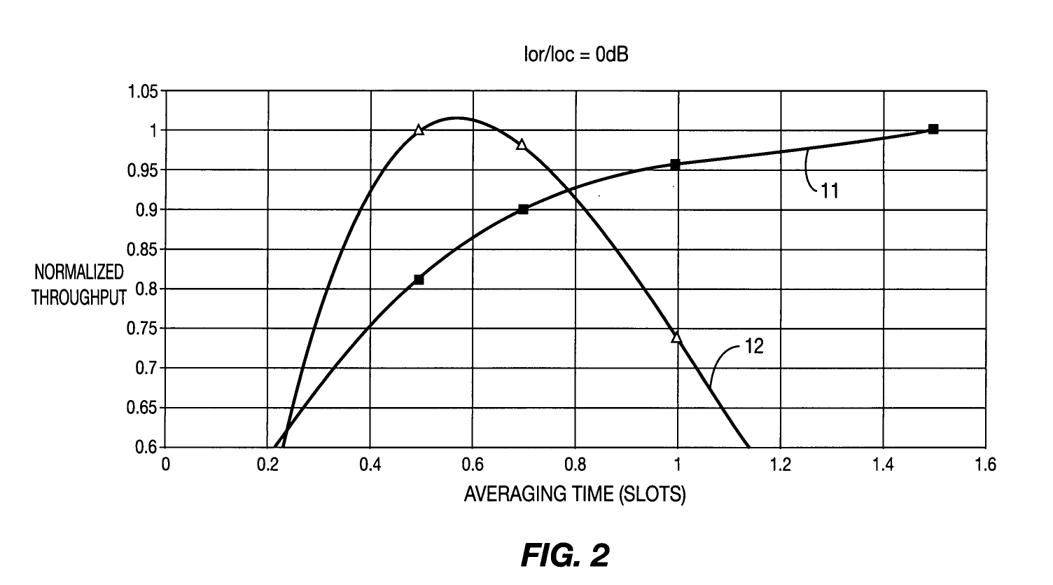

### DETAILED DESCRIPTION OF THE PREFERRED EMBODIMENT(S)

Although the embodiments are described in conjunction with a third generation partnership program (3GPP) wideband code division multiple access (W-CDMA) system, the embodiments are applicable to any hybrid code division multiple access (CDMA)/time division multiple access (TDMA) communication system. Additionally, the embodiments are applicable to CDMA systems, in general, such as CDMA2000, TD-SCDMA, the proposed frequency division duplex (FDD) mode of 3GPP W-CDMA and Orthogonal Frequency Division Multiplex (OFDM). Although receivers made in accordance with the invention have primary application for WTRUs configured as base stations or UEs, they may be employed for any type of WTRU which receives signals from another WTRU in a relative mobile context.

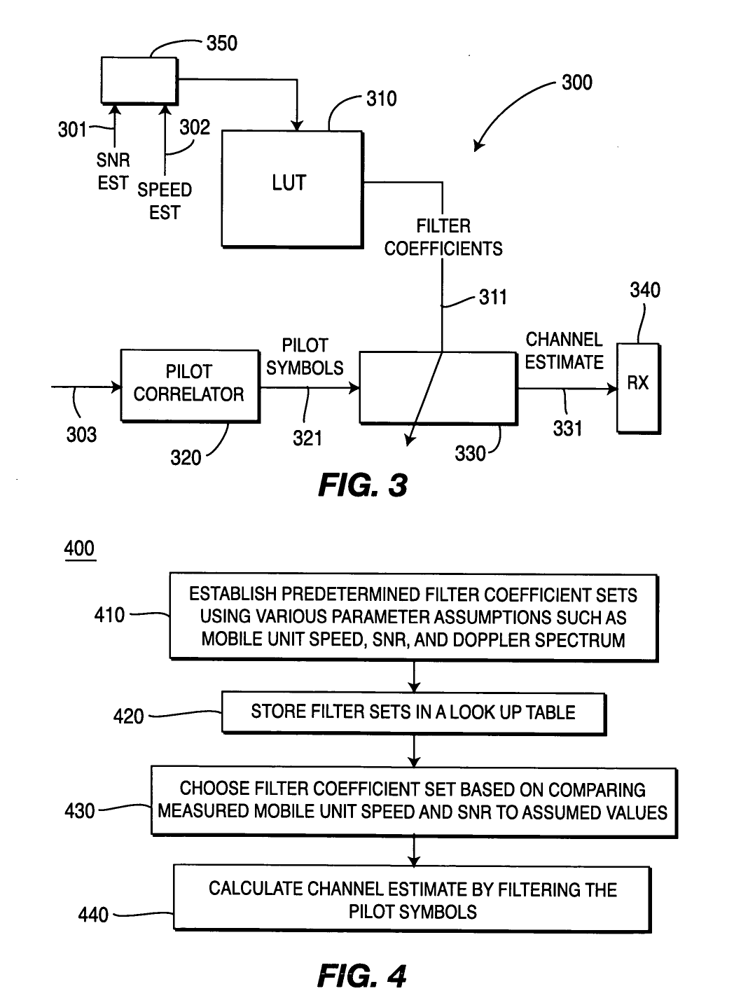

FIG. 3 shows a block diagram of a first embodiment of an adaptive channel estimation filter of a receiver according to the present invention. Adaptive filter configuration 300 comprises a lookup table (LUT) 310, a pilot correlator 320 and a filter 330. LUT 310 contains a set of pre-computed filters, preferably with finite impulse response (FIR) type coefficients. A preferred example of FIR type of filter coefficients to be used is an FIR Wiener filter. Alternatively, less complex infinite impulse response (IIR) coefficients may be used. A small number of filters, for example as few as six (6) filters, may be suitable to effectively cover the set of mobile WTRUs' speeds (3 kph to 250 kph) and SNRs (−3 dB to 16 dB) expected to be observed in a typical FDD deployment. The small number of filters is primarily due to the observation that most multipath Rayleigh channels will exhibit approximately classical Doppler spectrum, greatly limiting the dimension of required filters. Rician channels will tend to have sufficient SNR as to not require any special filters for channel estimation. Preferably, the LUT 310 is updatable such that the small number of filters is adjusted to cover assumed ranges of mobile WTRU speeds and SNRs, by extending the range and/or adding coefficient sets to increase the density, according to the trend of observed conditions.

LUT 310 receives mobile WTRU speed estimate input 301 and channel SNR estimate 302, which are calculated elsewhere by devices outside the scope of the present invention, such as from Doppler spread estimation.

Since only a small number of filter coefficients is desirable to be saved in the LUT memory, the estimated speed 301 and SNR 302 are used to select the nearest neighboring filter coefficient set. LUT 310 preferably contains sets of filter coefficients dense enough to minimize the performance losses associated with using the nearest neighbor filter. Index generator 350 selects the optimum filter coefficients from LUT 310 by comparing the current mobile WTRU speed estimate 301 and SNR estimate 302 to the set of predetermined mobile speed estimates and SNR estimates and selecting the closest match. Thus, the channel estimation is adaptive to the mobile WTRU speed and SNR estimates.

Where the communication signal 303 is a multipath signal and a separate SNR estimate 302 is available for each of P strongest signal paths, then LUT 310 may provide a set of coefficients 311 for each of the P signal paths. Otherwise, a single SNR estimate 302 can produce a single set of coefficients 311, which can still produce a channel estimate with minimal performance loss.

Pilot correlator 320 is configured to despread pilot signal into pilot symbols 321 from the received communication signal 303 according to known spreading codes associated with standard CDMA signal processing. Preferably, the pilot correlator 320 acts as a vector correlator, where the input and output signals are in vector format. Also, the received signal 303 is preferably descrambled by standard CDMA signal processing prior to despreading processing by the pilot correlator 320. Where the communication signal 303 is a multipath signal, pilot correlator 320 is preferably configured to produce a set of pilot symbols 321, one for each path, preferably for a predetermined number P of paths carrying the strongest multipath signals above a particular threshold.

Filter 330 is preferably configured to perform an inner product function (i.e., a vector dot product) of the pilot symbols 321 and the filter coefficients 311 (i.e., a FIR filter), which results in a channel estimate 331 for receiver 340. IIR and/or non-linear filters may also be used. Where multiple coefficient sets 311 and pilot symbols 321 are available due to P multipath signal considerations by LUT 310 and pilot correlator 320, filter 330 is preferably configured to produce P channel path estimates Cⱼ for further processing by receiver 340, where (j=1 to P). The composite set of channel path estimates Cⱼ is collectively referred to as a channel estimate 331.

FIG. 4 shows a method flowchart for the adaptive channel estimation filter described according to FIG. 3. Method 400 begins with step 410, where predetermined filter coefficients sets are established using various assumptions of parameters, such as speed, SNR and a Doppler spectrum to be used. In step 420, the filter coefficients are stored in memory as lookup table (LUT) 310. Next, index generator 350 selects the optimum filter coefficients from LUT 310 by comparing the current mobile speed estimate 301 and SNR estimate 302 to the set of predetermined mobile WTRU speed assumptions and SNR assumptions associated with the stored filter coefficients in the LUT 310 and selecting the closest match (step 430). Alternatively, the decision boundaries can be pre-computed by MSE analysis or performance simulation. In step 440, filter 330 filters the pilot symbols 321 by the filter coefficients 311, which results in a channel estimate 331 for receiver 340. Preferably, filter 330 performs an inner product function of the pilot symbols 321 and the filter coefficients 311.

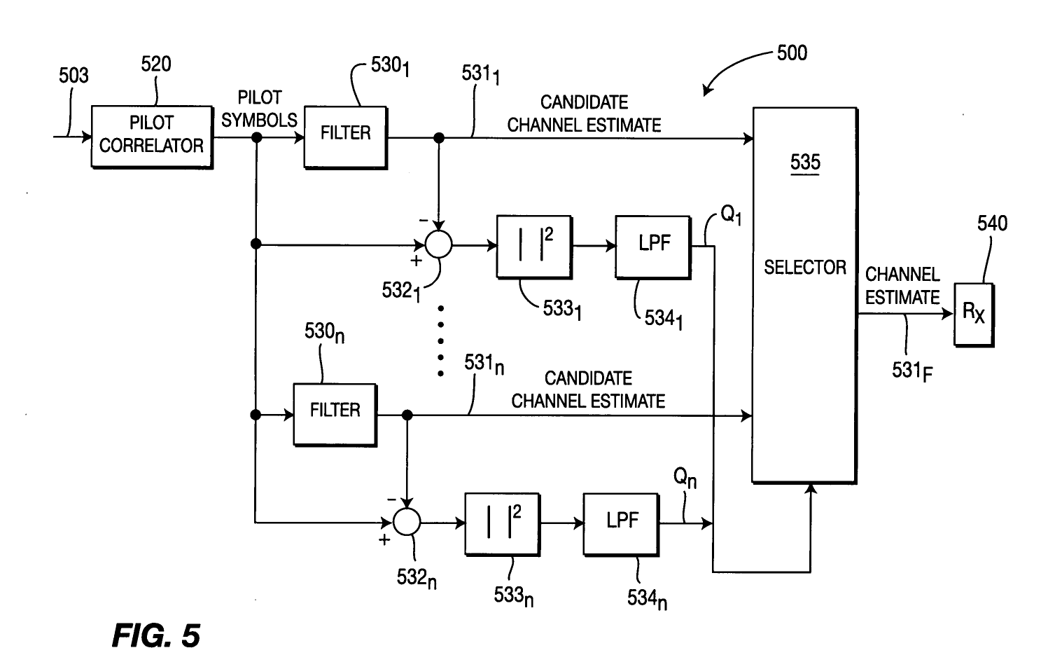

FIG. 5 shows a second embodiment of adaptive channel estimation according to the present invention. Channel estimation circuit 500 comprises pilot correlator 520, filters 530₁-530ₙ, adders 532₁-532ₙ, magnitude square units 533₁-533ₙ, low pass filters 534₁-534ₙ, and selector 535. Pilot correlator 520 is preferably configured to despread the descrambled pilot symbols 521 from the received communication signal 503 according to known spreading codes associated with standard CDMA signal processing. Instead of choosing a single filter coefficient set, as described in channel estimation circuit 300 for the first embodiment, each filter 530₁-530ₙ represents a candidate filter coefficient set and are preferably configured to all operate continuously to produce candidate channel estimates 531₁-531ₙ. Preferably, a Wiener type filter is selected for each of the filters 530₁-530ₙ. Each of the n filters is predetermined and selected so as to minimize performance losses due to having to select from a finite number of filters, while still covering the range of expected channel conditions. Preferably, the same filters derived for channel estimation circuit 300 are selected for channel estimation circuit 500. However, as all candidate filters 530₁-530ₙ are running continuously, filter associated transients are not an issue and lower complexity IIR filters are preferred. FIR filters may still be used, however, as an alternative. Preferably, the channel estimate selection is achieved by determining the quality of signal of each candidate channel estimate 531₁-531ₙ by a computational component as follows. For each filter 530₁-530ₙ, a summer 532₁-532ₙ subtracts the output from pilot correlator 520 from the channel estimate 531₁-531ₙ, which results in an estimation error including noise. Next, magnitude squaring by a magnitude square unit 533₁-533ₙ and averaging by a low pass filter 534₁-534ₙ yields a mean square error (MSE) estimate Q1-Qn associated with the channel estimate 531₁-531ₙ. Accordingly, each candidate channel estimation filter 530₁-530ₙ has its own self assessment circuit for determining the quality of the channel estimation. Selector 535 chooses the channel estimate 531_{F} from the candidate channel estimate 531₁-531ₙhaving the lowest mean square error estimate Q1-Qn, or the best quality signal. Alternatively, selector 535 calculates a SNR value associated with each candidate channel estimate 531₁-531ₙ and selects as the channel estimate 531_{F} that candidate channel estimate 531₁-531ₙ having the highest SNR. Thus, selector 535 produces an adaptive channel estimation that reacts to the varying channel conditions through a filter set chosen to cover the range of channel conditions.

Where the communication signal 503 is a multipath signal, pilot correlator 520 is preferably configured to produce a set of pilot symbols 521 for each path, preferably for P predetermined paths carrying the P strongest signals above a particular threshold. Each filter 530₁-530ₙ then produces P channel path estimates Cᵢⱼ for each channel estimate, and there are n corresponding MSE values for each candidate channel path estimate 531₁-531ₙ, where i is the index of estimates for (i=1 to n), and j is the path index for (j=1 to P). Preferably, a single MSE circuit, comprising one adder, a magnitude square unit, and a low pass filter, performs the MSE operation for the multiple vectors of channel path estimates. For example, to process the MSE for the multipath channel path estimate associated with filter 530₁, the adder 532₁, the magnitude square unit 533₁, and the low pass filter 534₁ are used to process each vector successively. Alternatively, multiple parallel MSE circuits may be used for simultaneous vector processing of the multipath pilot symbols and channel path estimates associated with a particular filter.

Finally, the composite channel estimate 531_{F} consists of P multipath values to be processed by receiver 540. The highest quality path estimate is selected for each of the P multipath components of the composite channel estimate 531_{F}. For example, for P=8 paths, and n=6 filters, channel estimate 531_{F} consists of the following composite set of channel estimates: [Cᵢ₁, Cᵢ₂, Cᵢ₃, Cᵢ₄, Cᵢ₅, Cᵢ₆, Cᵢ₇, Cᵢ₈], where the best path estimate for (i=1 to 6) is independently selected for each of the eight paths.

The difference between channel estimation circuit 500 and channel estimation circuit 300 is that the best channel estimation from among several candidates 531₁-531ₙ is selected by selector 535, rather than predicting the best filter for channel estimation as in channel estimation circuit 300. Another difference is that for channel estimation circuit 500, there are no accuracy concerns for the speed estimation of the mobile unit, or the SNR estimations since these parameters are not relied upon for the channel estimation filters 530₁-530ₙ.

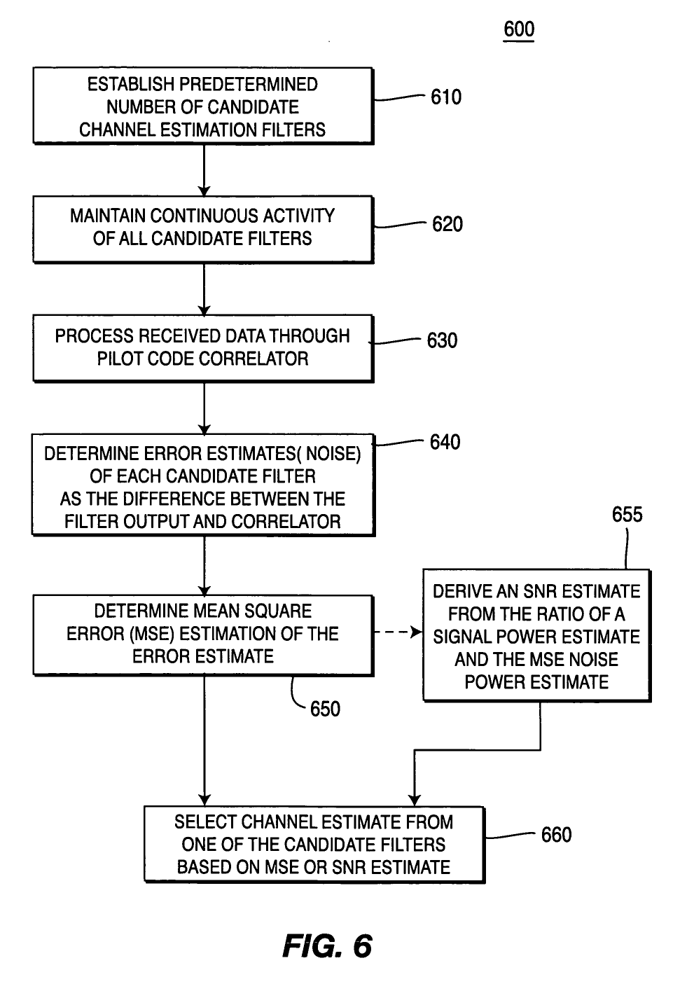

FIG. 6 shows a method flowchart for the adaptive channel estimation circuit 500. In step 610, a predetermined set of candidate channel estimation filters is established. The multiple candidate channel estimation filters run continuously to generate multiple channel estimates concurrently (step 620). The received data signal is processed by the pilot correlator by a despreading process based on known CDMA spreading codes (step 630). An error estimate of each channel estimation is determined as the difference between the channel estimation value and the correlator output (step 640). Next, the mean square error (MSE) of the error estimate is calculated (step 650). Optionally, the SNR estimate is derived from the channel estimate and the MSE estimate (step 655). Finally, the best channel estimate is selected as that having the lowest associated MSE estimate value, or highest SNR estimate value (step 660).

Although the first and second embodiments are described in terms of wireless communication between a base station and mobile WTRUs, the invention is readily applicable to WLAN communication between mobile units through an access unit in a IEEE 802.11 type system.

What is claimed is:

1. An apparatus for channel estimation in a receiver configured to receive wireless communication signals from at least one relatively mobile wireless transmit/receive unit (WTRU), the receiver being configured to determine an estimation of relative mobile speed and an estimation of the signal-to-noise ratio (SNR) of the relative mobile WTRU transmission, the apparatus, comprising:
a correlator configured to receive the communication signal data and to produce pilot symbols;
a memory configured to store predetermined filter coefficient sets having unique index values;
an index generator configured to match speed estimation values and SNR estimation values to a particular set of filter coefficients, and to select a corresponding index value in association with the memory to output a selected filter coefficient set; and
a filter configured to perform an inner product operation of the pilot symbols with the selected filter coefficient set output from the memory in association with the index generator to result in a channel estimation.

2. The apparatus of claim 1 configured to process wireless communication signals having P paths wherein the correlator is configured to produce P sets of pilot symbols, the index generator is configured to select corresponding indexes for P channel path estimates, and the filter is configured to produce a composite channel estimate comprising P channel path estimates.

3. The apparatus of claim 1 wherein memory contains predetermined coefficient filter sets which correspond to FIR Wiener type filters.

4. The apparatus of claim 1 configured to process wireless communication signals of a type from among one of FDD, W-CDMA, TD-SCDMA, OFDM, wireless LAN, or a combination thereof.

5. A wireless transmit receive unit (WTRU) having a receiver including the apparatus according to claim 1.

6. The WTRU of claim 5 configured as a base station for a cellular network.

7. The WTRU of claim 5 configured as an access point (AP) of a wireless local area network (WLAN).

8. The WTRU of claim 5 configured as a mobile unit.

9. An apparatus for channel estimation in a receiver configured to receive wireless communication signals from at least one relatively mobile wireless transmit/receive unit (WTRU), the receiver being configured to determine an estimation of relative mobile speed and an estimation of signal-to-noise ratio (SNR) of the relative mobile WTRU transmission, the apparatus comprising:
a correlator configured to receive communication signal data and to produce pilot symbols of received signals;
a plurality of N filters configured to process the pilot symbols produced, each with unique filter coefficients to in turn produce first through Nth candidate channel estimates;
a computational component configured to calculate a quality of signal for each of first through Nth candidate channel estimates; and
a selector configured to receive first through Nth candidate channel estimates and counterpart quality of signal values to select a channel estimate, which is the candidate channel estimate having the best quality of signal.

10. The apparatus of claim 9 wherein:
the computational component comprises a summer configured to subtract the pilot symbol from the candidate channel estimate, a magnitude square unit configured to calculate the squared value of the summer output, and a low pass filter to produce a mean square error from the magnitude square unit output; and
the selector is configured to select the channel estimate having the lowest mean square errorlookup table.

11. The apparatus of claim 9 wherein the computational component is configured to determine a signal to noise ratio (SNR) and the selector is configured to select the channel estimate having the highest SNR.

12. The apparatus of claim 9 configured to process wireless communication signals having P paths wherein the correlator is configured to produce P sets of pilot symbols, the plurality of N filters is configured to produce channel path estimates Cᵢⱼ, where i represents a channel estimate index for (i=1 to N) corresponding to a particular filter, and j represents a path index for (j=1 to P), and the selector is a filter configured to produce a composite channel estimate by selecting the best quality candidate channel estimate for each path represented by [Ci1, Ci2, . . . ,CiP].

13. The apparatus of claim 9 wherein the N plurality of filters correspond to IIR Wiener type filters.

14. The apparatus of claim 9 configured to process wireless communication signals of a type from among one of FDD, W-CDMA, TD-SCDMA, OFDM, wireless LAN, or combination thereof.

15. A wireless transmit receive unit (WTRU) having a receiver including the apparatus according to claim 9.

16. The WTRU of claim 9 configured as a base station for a cellular network.

17. The WTRU of claim 9 configured as an access point (AP) of a wireless local area network (WLAN).

18. The WTRU of claim 9 configured as a mobile unit.

19. A method for channel estimation of wireless communication signals received by a first wireless transmit/receive unit (WTRU) from at least one other relatively mobile WTRU, comprising:
establishing predetermined sets of channel estimate filter coefficients based on a plurality of assumed relative mobile speeds and a plurality of assumed signal-to-noise ratio (SNR) values;
estimating relative speed of the at least one transmitting station;
estimating SNR of the channel; and
selecting a filter set according to a closest match between the estimated speed and assumed speeds and between the estimated SNR values and assumed SNR values.

20. The method of claim 19 wherein the selecting is based on mean square error (MSE) estimation analysis.

21. The method of claim 19 wherein the selecting is based on performance simulation.

22. The method of claim 19 wherein the establishing minimizes losses associated with nearest neighbor filtering by maintaining a density of filter coefficient sets.

23. The method of claim 19 further comprising storing the sets of filter coefficients in a memory.

24. The method of claim 23 wherein the memory is configured as a lookup table.

25. The method of claim 24 further comprising updating the lookup table coefficients with additional sets of filter coefficients based on subsequent measurements of relative mobile speed and channel SNR.

26. A method for channel estimation of wireless communication signal data received by a first wireless transmit/receive unit (WTRU) from at least one other relatively mobile WTRU, comprising:
despreading received the communication signal data to produce pilot symbols of the received signal;
processing by a plurality of N filters the pilot symbols sets of filter coefficients unique to each filter to produce first through Nth candidate channel estimates;
calculating a quality of signal for each of first through Nth candidate channel estimates; and
selecting a channel estimate from first through Nth candidate channel estimates according to the candidate channel estimate having the best quality of signal.

27. The method of claim 26 wherein the calculating quality of signal for each candidate channel estimate further comprises:
subtracting the pilot symbol from the candidate channel estimate to produce an error estimate value;
calculating the magnitude square value of the error estimate;
producing a mean square error from the magnitude square unit output; and
selecting the channel estimate having the lowest mean square error.

28. The method of claim 26 wherein the calculating the quality of signal determines a signal to noise ratio (SNR), and the selecting the channel estimate is according to the candidate channel estimate having the highest SNR.

29. The method of claim 26 wherein the wireless communication signal comprises P paths, the despreading produces P sets of pilot symbols, the processing by the plurality of N filters produces channel path estimates Cᵢⱼ, where i represents a channel estimate index for (i=1 to N) corresponding to a particular filter, and j represents a path index for (j=1 to P), and the selecting produces a composite channel estimate by selecting the best quality candidate channel estimate for each path represented by [Cᵢ₁, Cᵢ₂, . . . ,C_{iP}].
